(19) United States
(12) Patent Application Publication
(10) Pub. No.: US 2011/0128592 A1
(43) Pub. Date: Jun. 2, 2011

(54) ERECTING EQUAL-MAGNIFICATION LENS ARRAY PLATE, OPTICAL SCANNING UNIT, AND IMAGE READING DEVICE

(75) Inventors: Haruhiko MAMADA, Minato-ku (JP); Shiro Sato, Minato-ku (JP); Katsuhide Shimmo, Minato-ku (JP)

(73) Assignee: NIPPON SHEET GLASS COMPANY, LIMITED, Tokyo (JP)

(21) Appl. No.: 12/957,933

(22) Filed: Dec. 1, 2010

(30) Foreign Application Priority Data
Dec. 2, 2009 (JP) 2009-274772

(51) Int. Cl. H04N 1/04; G02B 27/12

(52) U.S. Cl. 358/474; 359/622

(57) ABSTRACT

An erecting equal-magnification lens array plate includes: a first lens array plate and a second lens array plate each provided with a plurality of convex lenses on both surfaces; a first light-shielding member provided with a plurality of first openings; and a second light-shielding member provided with a plurality of second openings. The first lens array plate and the second lens array plate form a stack such that a combination of the lenses associated with each other form a coaxial lens system. The first light-shielding member is provided on the first lens array plate such that the first opening is located opposite to the corresponding convex lens. The second light-shielding member is provided on the second lens array plate such that the second opening is located opposite to the corresponding fourth lens. An open end of each of the first opening and the second opening facing the lens is formed to become progressively larger in diameter toward the end.

### BACKGROUND OF THE INVENTION

1. Field of the Invention

The present invention relates to erecting equal-magnification lens array plates, optical scanning units, and image reading devices.

2. Description of the Related Art

Some image reading devices such as scanners and image forming devices such as LED printers are known to use erecting equal-magnification optics. Erecting equal-magnification optics are capable of reducing the size of devices better than reduction optics. In the case of image reading devices, an erecting equal-magnification optical system comprises a line light source, an erecting equal-magnification lens array, and a line image sensor. In the case of image forming devices, an erecting equal-magnification optical system comprises a line light source, an erecting equal-magnification lens array, and a photosensitive drum.

A rod lens array capable of forming an erect equal-magnification image is conventionally used as an erecting equal-magnification lens array in an erecting equal-magnification optical system. Recently, there is proposed a lens array unit formed as a stack of a plurality of transparent lens array plates built such that the optical axes of individual convex lenses are aligned, where each transparent lens array plate includes a systematic arrangement of micro-convex lenses on both planes. Since a lens array unit such as this comprises a stack of lens array plates formed by, for example, injection molding, an erecting equal-magnification lens array can be manufactured at a relatively low cost.

A lens array unit lacks a wall for beam separation between adjacent lenses. Therefore, there is a problem of stray light wherein a light beam diagonally incident on the lens array unit travels diagonally inside the plate and enters an adjacent convex lens, creating a ghost image as it leaves the plate.

Patent document No. 1 discloses a technology to address stray light whereby the first lens array facing an object on which an image is formed is fitted with a light shielding member for regulating light traveling from the object.

[patent document No. 1] JP2001-352429

In the lens array unit described in patent document No. 1, the shielding member is fitted to the first lens array such that the plurality of through holes formed in the shielding member are aligned opposite to the corresponding lenses formed in the first lens array by allowing a projection provided in the first lens array to fit a recess provided in the shielding member.

When an assembly of the first lens array and the shielding member is formed by fitting a projection to a recess as in patent document 1, it is difficult to align the first lens array and the shielding member precisely so that there is room for improvement in the ease of assembly because certain allowance in the diameter of the hole is required for hole-based fitting.

### SUMMARY OF THE INVENTION

The present invention addresses the aforementioned disadvantage and a purpose thereof is to provide a technology capable of improving the ease of assembly of the erecting equal-magnification lens array plate.

The erecting equal-magnification lens array plate that addresses the above-described disadvantage comprises: a first lens array plate provided with a plurality of first lenses arranged systematically on a first surface of the plate and with a plurality of second lenses arranged systematically on a second surface opposite to the first surface; and a second lens array plate provided with a plurality of third lenses arranged systematically on a third surface of the plate and with a plurality of fourth lenses arranged systematically on a fourth surface opposite to the third surface, a first light-shielding member provided with a plurality of first openings; and a second light-shielding member provided with a plurality of second openings. The first lens array plate and the second lens array plate form a stack such that the second surface and the third surface face each other to ensure that a combination of the lenses associated with each other form a coaxial lens system, the first light-shielding member is provided on the first surface such that the first opening is located opposite to the corresponding first lens, the second light-shielding member is provided on the fourth surface such that the second opening is located opposite to the corresponding fourth lens. An open end of the first opening and/or the second opening facing the lens is formed to become progressively larger in diameter toward the end.

By forming the open end of the first opening and the second opening facing the lens is formed to become progressively larger in diameter toward the end, the first opening and the second opening can be easily aligned with the first lens and the fourth lens, respectively, when the first lens array plate and the second lens array plate are provided on the first surface and the fourth surface, respectively. As a result, the ease of assembly of the erecting equal-magnification lens array plate is improved.

An open end of the first opening and/or the second opening facing the lens may be tapered. An open end of the first opening and/or the second opening facing the lens may be formed along the outline of the corresponding lens.

The erecting equal-magnification lens array plate may further comprise: a third light-shielding member provided with a plurality of third openings and provided between the first lens array plate and the second lens array plate such that the third opening is located opposite to the corresponding second lens and the corresponding third lens, wherein an open end of the third opening facing the second lens and/or the third lens is formed to become progressively larger in diameter toward the end. In this case, the third opening can be easily aligned with the second lens and the third lens when the third light-shielding member is provided between the first lens array plate and the second lens array plate.

Another embodiment of the present invention relates to an optical scanning unit. The optical scanning unit comprises: a line light source configured to illuminate an image to be read; the erecting equal-magnification lens array plate configured to condense light reflected by the image to be read; a line image sensor configured to receive light transmitted by the erecting equal-magnification lens array plate; and a housing for securing the line light source, the erecting equal-magnification lens array, and the line image sensor in their places.

According to the embodiment, an inexpensive optical scanning unit is made available by using the above-described erecting equal-magnification lens array plate in which the ease of assembly is improved.

Still another embodiment of the present invention relates to an image reading device. The device comprises the above-described optical scanning unit and an image processing unit configured to process an image signal detected by the optical scanning unit.

According to the embodiment, an inexpensive image reading device is made available by using the above-described erecting equal-magnification lens array plate in which the ease of assembly is improved.

### BRIEF DESCRIPTION OF THE DRAWINGS

FIG. 1 shows an image reading device according to an embodiment of the present invention;

FIG. 2 shows a partial cross section of the erecting equal-magnification lens array plate in the main scanning direction;

FIG. 3 shows the erecting equal-magnification lens array plate according to another embodiment of the present invention;

FIG. 4 shows the erecting equal-magnification lens array plate according to still another embodiment of the present invention; and

FIG. 5 shows the erecting equal-magnification lens array plate according to yet another embodiment of the present invention.

### DETAILED DESCRIPTION OF THE INVENTION

The invention will now be described by reference to the preferred embodiments. This does not intend to limit the scope of the present invention, but to exemplify the invention.

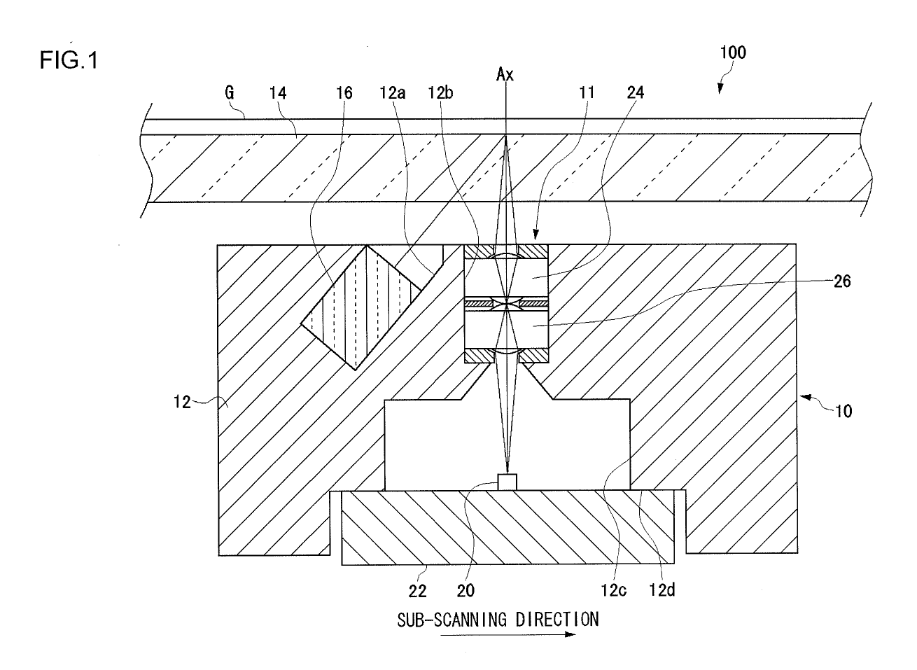

FIG. 1 shows an image reading device 100 according to an embodiment of the present invention. As shown in FIG. 1, the image reading device 100 comprises an optical scanning unit 10, a glass plate 14 on which a document G is placed, a driving mechanism (not shown) for driving the optical scanning unit 10, and an image processing unit (not shown) for processing data read by the optical scanning unit 10.

The optical scanning unit 10 comprises a line light source 16 for illuminating a document G placed on a glass plate 14, an erecting equal-magnification lens array plate 11 for condensing light reflected from the document G, a line image sensor (photoelectric transducer) 20 for receiving light condensed by the erecting equal-magnification lens array plate 11, and a housing 12 for housing the line light source 16, the erecting equal-magnification lens array plate 11, and the line image sensor 20.

The housing 12 is substantially cubic in shape. A first recess 12a and a second recess 12b are formed in the upper part of the housing 12 and a third recess 12c is formed in the lower part. The housing 12 is formed injection-molding a resin. By forming the housing 12 by injection molding, the housing 12 can be formed easily at a low cost. The line light source 16 is diagonally fixed inside the first recess 12a. The line light source 16 is secured such that the optical axis of the illuminating light passes through the intersection of the optical axis Ax of the erecting equal-magnification lens array plate 11 and the top surface of the glass plate 14.

The erecting equal-magnification lens array plate 11 is fitted in the second recess 12b. A substrate 22 provided with the line image sensor 20 is fitted in the third recess 12c. The substrate 22 is secured such that the top surface thereof is in contact with a step 12d provided in the third recess 12c.

As described later, the erecting equal-magnification lens array plate 11 comprises a stack of a first lens array plate 24 and a second lens array plate 26 such that pairs of corresponding lenses form coaxial lens systems, where each lens array plate is formed with a plurality of convex lenses on both planes of the plate. The first lens array plate 24 and the second lens array plate 26 are held by a holder (not shown) in a stacked state.

The erecting equal-magnification lens array plate 11 is installed in the image reading device 100 such that the longitudinal direction thereof is aligned with the main scanning direction and the lateral direction thereof is aligned with the sub-scanning direction. The erecting equal-magnification lens array plate 11 is configured to receive line light reflected from the document G located above and form an erect equal-magnification image on an image plane located below, i.e., a light-receiving surface of the line image sensor 20. The image reading device 100 can read the document G by scanning document G with the optical scanning unit 10 in the sub-scanning direction.

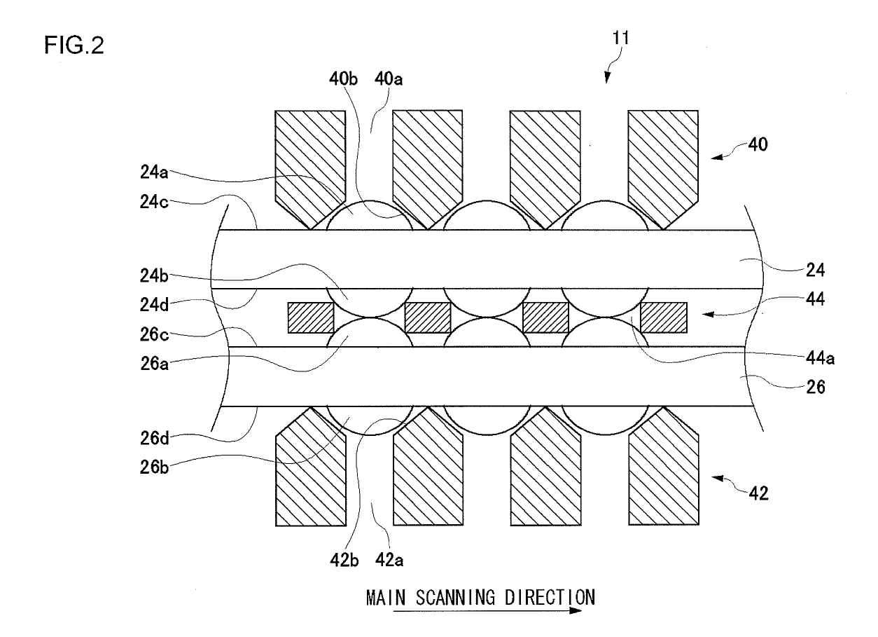

FIG. 2 shows a partial cross section of the erecting equal-magnification lens array plate 11 in the main scanning direction. Referring to FIG. 2, the horizontal direction in the illustration represents the main scanning direction (longitudinal direction) of the erecting equal-magnification lens array plate 11 and the depth direction in the illustration represents the sub-scanning direction (lateral direction).

As described above, the erecting equal-magnification lens array plate 11 comprises a stack of the first lens array plate 24 and the second lens array plate 26. Each of the first lens array plate 24 and the second lens array plate 26 is a rectangular plate provided with an arrangement of a plurality of convex lenses on both sides thereof.

The first lens array plate 24 and the second lens array plate 26 are formed by injection molding. Preferably, each of the first lens array plate 24 and the second lens array plate 26 is formed of a material amenable to injection molding, having high light transmittance in a desired wavelength range, and having low water absorbability. Desired materials include cycloolefin resins, olefin resins, norbornene resins, and polycarbonate.

A plurality of first lenses 24a are arranged in a single line on a first surface 24c (one of the surfaces of the first lens array plate 24) in the longitudinal direction of the first lens array plate 24. A plurality of second lenses 24b are arranged in a single line on a second surface 24d of the first lens array plate 24 opposite to the first surface 24c in the longitudinal direction of the first lens array plate 24.

A plurality of third lenses 26a are arranged in a single line on a third surface 26c (one of the surfaces of the second lens array plate 26) in the longitudinal direction of the second lens array plate 26. A plurality of fourth lenses 26b are arranged in a single line on a fourth surface 26d opposite to the third surface 26c in the longitudinal direction of the second lens array plate 26.

In this embodiment, it is assumed that the first lens 24a, the second lens 24b, the third lens 26a, and the fourth lens 26b are spherical in shape. Alternatively, the lenses may have aspherical shapes.

The erecting equal-magnification lens array plate 11 is provided with a first light shielding member 40 for preventing stray light from entering the first lens 24a. The first light shielding member 40 is formed by providing a plurality of first openings 40a in a plate-shaped light-absorbing member. Preferably, the shielding material for forming the first light shielding member 40 is amenable to injection molding and is highly capable of shielding light in a required wavelength band. For example, a black ABS resin may be used. The first openings 40a are circular openings in a plan view and are arranged in a single line in the longitudinal direction of the first light-shielding member 40 at the same pitch as the first lenses 24a. The height of the first light shielding member 40 is set to remove light entering at an angle larger than a predetermined maximum angle of view. The first light-shielding member 40 formed as described above is provided on the first surface 24c of the first lens array plate 24 such that the first opening 40a is located opposite to the corresponding first lens 24a. As shown in FIG. 2, the space around the first lens 24a is covered by the first light shielding member 40 so as to shield stray light from entering the first lens 24a.

In this embodiment, an open end 40b of the first opening 40a facing the first lens 24a is tapered, becoming progressively larger in diameter toward the end. The tapered portion of the open end 40b is in contact with the outer periphery of the first lens 24a (in FIG. 2, the first lens 24a and the open end 40b are slightly spaced apart for clear illustration). By tapering the open end 40b of the first opening 40a to become progressively larger in diameter toward the end, the erecting equal-magnification lens array plate 11 can be assembled by providing the first light-shielding member 40 on the first lens array plate 24 such that the first opening 40a is self-aligned opposite to the first lens 24a without precise alignment. Therefore, the first light-shielding member 40 can be provided on the first lens array plate 24 without using a special-purpose jig or the like.

The erecting equal-magnification lens array plate 11 is also provided with a second light shielding member 42 for shielding stray light exiting the fourth lenses 26b. The second light-shielding member 42 is formed similarly as the first light-shielding member 40 and is provided with a plurality of second openings 42a. The second light-shielding member 42 is provided on the fourth surface 26d of the second lens array plate 26 such that the second opening 42a is located opposite to the corresponding fourth lens 26b. As shown in FIG. 2, the space around the fourth lenses 26b is covered by the second light shielding member 42 so as to shield stray light exiting the fourth lens 26b.

Like the first opening 40a, an open end 42b of the second opening 42a facing the fourth lens 26b is tapered, becoming progressively larger in diameter toward the end. The tapered portion of the open end 42b is in contact with the outer periphery of the fourth lens 26b (in FIG. 2, the fourth lens 26b and the open end 42b are slightly spaced apart for clear illustration). By tapering the open end 42b of the second opening 42a to become progressively larger in diameter toward the end, the second light-shielding member 42 is provided on the second lens array plate 26 such that the second opening 42a is self-aligned opposite to the fourth lens 26b without precise alignment. Therefore, the second light-shielding member 42 can be provided on the second lens array plate 26 without using a special-purpose jig or the like.

Further, the erecting equal-magnification lens array plate 11 comprises a third light-shielding member 44 between the first lens array plate 24 and the second lens array plate 26. The third light shielding member 44 is formed by providing a plurality of third openings 44a in a plate-shaped light-absorbing member. The third light-shielding member 44 can be formed by using a material similar to that of first and second light-shielding members 40 and 42. The third openings 44a are circular openings in a plan view and are arranged in a single line in the longitudinal direction of the third light-shielding member 44 at the same pitch as the second and third lenses 24b and 26a. The third light-shielding member 44 formed as described above is provided between the first lens array plate 24 and the second lens array plate 26 such that the third opening 44a is located opposite to the corresponding second lens 24b and the corresponding third lens 26a. Since the stray light passing through the first lens array plate 24 is shielded by the third light-shielding member 44, imaging performance is further improved.

As described above, the erecting equal-magnification lens array plate 11 is configured such that the open end 40b of the first opening 40a and the open end 42b of the second opening 42a are tapered, becoming progressively larger in diameter toward the end. This allows the first opening 40a and the second opening 42a to be self-aligned with the first lens 24a and the fourth lens 26b, respectively, so that the first light-shielding member 40 and the second light-shielding member 42 can be provided on the first lens array plate 24 and the second lens array plate 26, respectively, without using any special-purpose jig or the like. Accordingly, the ease of assembly of the erecting equal-magnification lens array plate 11 is improved.

Further, according to the erecting equal-magnification lens array plate 11, concavo-convex engagement for aligning the lens array plate with the light-shielding member is not necessary. Therefore, the structure of the first lens array plate 24, the second lens array plate 26, the first light-shielding member 40, and the second light-shielding member 42 is simplified. In this way, the erecting equal-magnification lens array plate 11 can be made available at a reduced price. The process of tapering the open end 40b of the first opening 40a and the open end 42b of the second opening 42a to become progressively larger in diameter toward the end is implemented easily by forming the first light-shielding member 40 and the second light-shielding member 42 by injection molding and so does not particularly increase the cost.

Further, according to the erecting equal-magnification lens array plate 11, the first opening 40a and the second opening 42a are self-aligned with the first lens 24a and the fourth lens 26b, respectively, so that the optical axes of the first lens 24a and the fourth lens 26b can be easily aligned with the central axes of the first opening 40a and the second opening 42a, respectively. Once the plate is assembled, displacement between the optical axes of the lenses and the central axes of the openings rarely occurs. As a result, imaging performance of the erecting equal-magnification lens array plate 11 is improved.

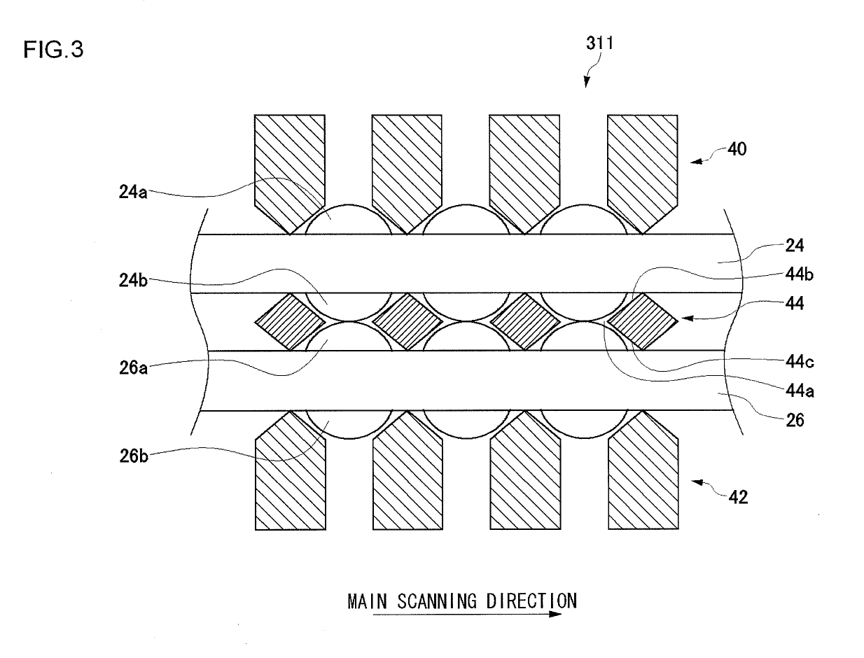

FIG. 3 shows an erecting equal-magnification lens array plate 311 according to another embodiment of the present invention. The components of this embodiment identical to or similar to those of the erecting equal-magnification lens array plate 11 shown in FIG. 2 are represented by like numerals and the description is omitted as appropriate.

The erecting equal-magnification lens array plate 311 according to this embodiment is different from the erecting equal-magnification lens array plate 11 shown in FIG. 2 in respect of the structure of the third light-shielding member 44. The third light-shielding member 44 according to this embodiment is configured such that an open end 44b of the third opening 44a facing the second lens 24b is tapered, becoming progressively larger in diameter toward the end. The tapered portion of the open end 44b is in contact with the outer periphery of the second lens 24b (in FIG. 3, the second lens 24b and the open end 44b are slightly spaced apart for clear illustration). Further, an open end 44c of the third opening 44a facing the third lens 26a is also tapered, becoming progressively larger in diameter toward the end. The tapered portion of the open end 44c is in contact with the outer periphery of the third lens 26a (in FIG. 3, the third lens 26a and the open end 44c are slightly spaced apart for clear illustration).

By using the third light-shielding member 44 formed as described above, the third light-shielding member 44 is provided between the first lens array plate 24 and the second lens array plate 26 such that the third opening 44a is self-aligned opposite to the second lens 24b and the third lens 26a without precise alignment. Therefore, the third light-shielding member 44 can be provided between the first lens array plate 24 and the second lens array plate 26 without using a special-purpose jig or the like.

Further, according to the erecting equal-magnification lens array plate 311, concavo-convex engagement for aligning the first lens array plate 24 and the second lens array plate 26 with the third light-shielding member 44 is not necessary. Therefore, the structure of the first lens array plate 24, the second lens array plate 26, and the third light-shielding member 44 is simplified. In this way, the erecting equal-magnification lens array plate 311 can be made available at a reduced price.

Further, according to the erecting equal-magnification lens array plate 311, the third opening 44a is self-aligned with the second lens 24b and the third lens 26a so that the optical axes of the second lens 24b and the third lens 26a can be easily aligned with the central axis of the third opening 44a. Once the plate is assembled, displacement between the optical axes of the lenses and the central axes of the openings rarely occurs. As a result, imaging performance of the erecting equal-magnification lens array plate 311 is improved.

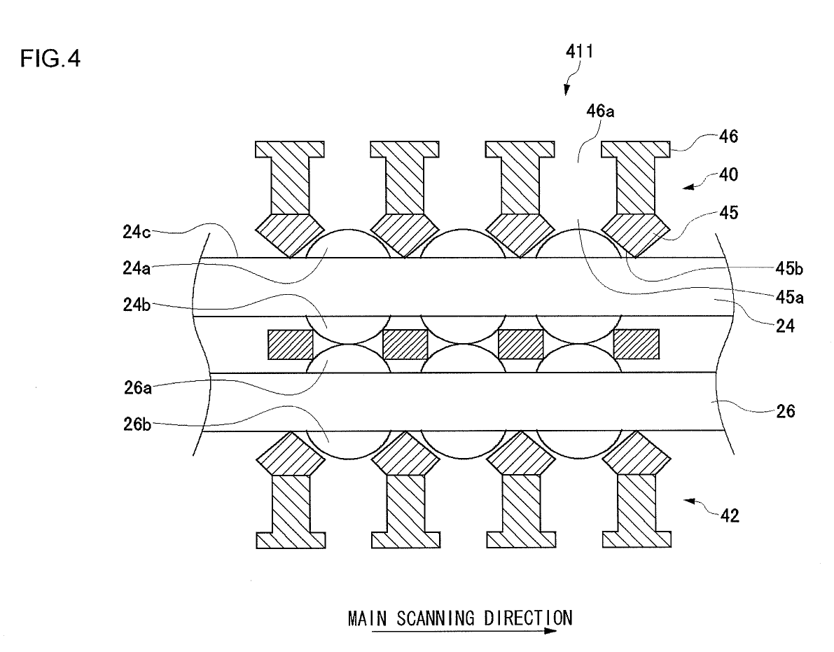

FIG. 4 shows an erecting equal-magnification lens array plate 411 according to still another embodiment of the present invention. The components of this embodiment identical to or similar to those of the erecting equal-magnification lens array plate 11 shown in FIG. 2 are represented by like numerals and the description is omitted as appropriate.

The erecting equal-magnification lens array plate 411 according to this embodiment is different from the erecting equal-magnification lens array plate 11 shown in FIG. 2 in respect of the structure of the first light-shielding member 40 and the second light-shielding member 42. Each of the first light-shielding member 40 and the second light-shielding member 42 according to this embodiment comprises two members. Since the second light-shielding member 42 is similarly structure as the first light-shielding member 40, a description will be given of the first light-shielding member 40 by way of example.

The first light-shielding member 40 comprises a lower member 45 provided on the first surface 24c of the first lens array plate 24, and an upper member 46 provided on the lower member 45.

The lower member 45 is formed by providing a plurality of lower openings 45a in a thin plate-shaped light-absorbing member. The lower openings 45a are circular openings in a plan view and are arranged in a single line in the longitudinal direction at the same pitch as the first lenses 24a. The lower member 45 formed as described above is provided on the first surface 24c of the first lens array plate 24 such that the lower opening 45a is located opposite to the corresponding first lens 24a.

The upper member 46 is formed by providing a plurality of upper openings 46a in a thin plate-shaped light-absorbing member. The upper openings 46a are arranged in a single line in the longitudinal direction at the same pitch as the first lenses 24a. In this embodiment, the upper openings 46a are formed such that the diameter of the opening at an open end opposite to the first lens 24a is smaller than that of the other portions.

The upper and lower members 45 and 46 formed as described above form a stack such that the central axes of the lower openings 45a and the upper opening 46a are aligned. By building the first light-shielding member 40 from two constituting elements, openings of complex shape as shown in FIG. 4 are formed, thereby achieving desired stray light removal performance.

In this embodiment, an open end 45b of the lower opening 45a of the lower member 45 facing the first lens 24a is tapered, becoming progressively larger in diameter toward the end. The tapered portion of the open end 45b is in contact with the outer periphery of the first lens 24a (in FIG. 4, the first lens 24a and the open end 45b are slightly spaced apart for clear illustration). In this way, the lower opening 45a is self-aligned opposite to the first lens 24a without precise alignment. Therefore, the lower member 45 can be provided on the first lens array plate 24 without using a special-purpose jig or the like. Further, since concavo-convex engagement for aligning the lower member 45 with the lens array plate is not necessary, the structure of the lower member 45 and the first lens array plate 24 is simplified. The upper member 46 is aligned and fitted to the lower member using concavo-convex engagement.

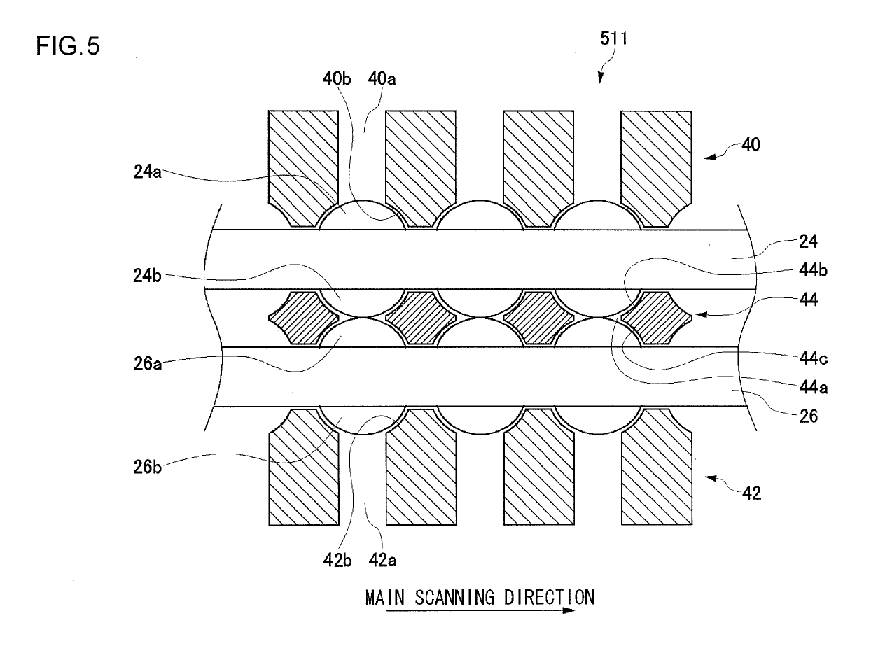

FIG. 5 shows an erecting equal-magnification lens array plate 511 according to still another embodiment of the present invention. The components of this embodiment identical to or similar to those of the erecting equal-magnification lens array plate 11 shown in FIG. 2 are represented by like numerals and the description is omitted as appropriate.

The erecting equal-magnification lens array plate 511 according to this embodiment is different from the erecting equal-magnification lens array plate 11 shown in FIG. 2 in respect of the structure of the first light-shielding member 40, the second light-shielding member 42, and the third light-shielding member 44. The first light-shielding member 40 according to this embodiment is configured such that an open end 40b of the first opening 40a facing the first lens 24a is spherically formed along the outline of the corresponding first lens 24a, becoming progressively larger in diameter toward the end. The second light-shielding member 42 is configured such that an open end 42b of the second opening 42a is spherically formed along the outline of the corresponding fourth lens 26b and becoming progressively larger in diameter toward the end. The third light-shielding member 44 is configured such that an open end 44b of the third opening 44a facing the second lens 24b is spherically formed along the outline of the corresponding second lens 24b and becoming progressively larger in diameter toward the end. Further, the an open end 44c of the third opening 44a facing the third lens 26a is spherically formed along the outline of the corresponding third lens 26a and becoming progressively larger in diameter toward the end. The spherically shaped portion of each open end is in contact with the outer periphery of the corresponding lens (in FIG. 5, the lens and the open end are slightly spaced apart for clear illustration).

By using the first light-shielding member 40, the second light-shielding member 42, and third light-shielding member 44 formed as described above, the open end of each light-shielding member is self-aligned opposite to the corresponding lens without performing precise alignment when providing the light-shielding members. Therefore, the light-shielding members can be provided without using a special-purpose jig or the like so that the ease of assembly is improved.

Further, according to the erecting equal-magnification lens array plate 511, concavo-convex engagement for aligning the lens array plate with the light-shielding member is not necessary. Therefore, the structure of the constituting elements is simplified. In this way, the erecting equal-magnification lens array plate 511 can be made available at a reduced price.

Further, according to the erecting equal-magnification lens array plate 511, the open end of each light-shielding member is self-aligned opposite to the corresponding lens so that the optical axes of lenses can be easily aligned with the central axes of the openings, respectively. Once the plate is assembled, displacement between the optical axes of the lenses and the central axes of the openings rarely occurs. As a result, imaging performance of the erecting equal-magnification lens array plate 511 is improved.

In this embodiment, the lens is spherically formed so that the open end is spherically formed. However, the open end may be formed along the outline of the corresponding lens. For example, when the lens shape is aspherical, the open end may be aspherically formed, becoming progressively larger in diameter toward the end.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. An erecting equal-magnification lens array plate comprising:
a first lens array plate provided with a plurality of first lenses arranged systematically on a first surface of the plate and with a plurality of second lenses arranged systematically on a second surface opposite to the first surface; and
a second lens array plate provided with a plurality of third lenses arranged systematically on a third surface of the plate and with a plurality of fourth lenses arranged systematically on a fourth surface opposite to the third surface,
a first light-shielding member provided with a plurality of first openings; and
a second light-shielding member provided with a plurality of second openings;
wherein the first lens array plate and the second lens array plate form a stack such that the second surface and the third surface face each other to ensure that a combination of the lenses associated with each other form a coaxial lens system,
the first light-shielding member is provided on the first surface such that the first opening is located opposite to the corresponding first lens,
the second light-shielding member is provided on the fourth surface such that the second opening is located opposite to the corresponding fourth lens, and
an open end of the first opening and/or the second opening facing the lens is formed to become progressively larger in diameter toward the end.

2. The erecting equal-magnification lens array plate according to claim 1,
wherein an open end of the first opening and/or the second opening facing the lens is tapered.

3. The erecting equal-magnification lens array plate according to claim 1,
wherein an open end of the first opening and/or the second opening facing the lens is formed along the outline of the corresponding lens.

4. The erecting equal-magnification lens array plate according to claim 1, further comprising:
a third light-shielding member provided with a plurality of third openings and provided between the first lens array plate and the second lens array plate such that the third opening is located opposite to the corresponding second lens and the corresponding third lens,
wherein an open end of the third opening facing the second lens and/or the third lens is formed to become progressively larger in diameter toward the end.

5. The erecting equal-magnification lens array plate according to claim 4,
wherein an open end of the third opening facing the second lens and/or the third lens is tapered.

6. The erecting equal-magnification lens array plate according to claim 4,
wherein an open end of the third opening facing the second lens and/or the third lens is formed along the outline of the corresponding lens.

7. An optical scanning unit comprising:
a line light source configured to illuminate an image to be read;
the erecting equal-magnification lens array plate according to claim 1 configured to condense light reflected by the image to be read;
a line image sensor configured to receive light transmitted by the erecting equal-magnification lens array plate; and
a housing for securing the line light source, the erecting equal-magnification lens array, and the line image sensor in their places.

8. An image reading device comprising:
the optical scanning unit according to claim 7; and
an image processing unit configured to process an image signal detected by the optical scanning unit.
